(19) United States
(12) Patent Application Publication
(10) Pub. No.: US 2015/0326693 A1
(43) Pub. Date: Nov. 12, 2015

(54) METHOD AND SYSTEM FOR MULTILATERAL CONTENTS SERVICE FOR PROVIDING INTEREST REGION BY UTILIZING SHARED REGION IN HIGH RESOLUTION CONTENTS

(71) Applicant: Electronics and Telecommunications Research Institute, Daejeon (KR)

(72) Inventor: Kang Woon HONG, Daejeon (KR)

(21) Appl. No.: 14/707,560

(22) Filed: May 8, 2015

(30) Foreign Application Priority Data
May 9, 2014 (KR) 10-2014-0055392

(51) Int. Cl. H04L 29/06; H04L 29/08

(52) U.S. Cl. CPC H04L 67/42; H04L 65/403; H04L 67/2809; H04L 67/10

(57) ABSTRACT

The present invention discloses a method for multilateral contents service utilizing shared region including delivering interest region information to a server through a proxy system, which is performed by at least one client apparatus, extracting shared region contents for the shared region which is shared among at least one interest region from the original contents, which is performed by the server, delivering the shared region contents and, the relevant information between the shared region and interest region of a first client—the first client is one of the at least one of clients—to the proxy system, which is performed by the server, and generating the interest region contents based on the contents and relevant information received from the server to deliver it to the first client apparatus, which is performed by the proxy system.

### CROSS-REFERENCE TO RELATED APPLICATIONS

This application claims the benefit of priority of Korean Patent Application No. 10-2014-0055392 filed on May 9, 2014, all of which are incorporated by reference in their entirety herein.

### BACKGROUND OF THE INVENTION

1. Field of the Invention

The present invention relates to a method and system for multilateral contents service, and more particularly, to a method and system for multilateral contents service, which are able to reduce network bandwidth required when servicing different interest regions for a single content.

2. Discussion of the Related Art

In contents providing services, it is required for an identical content to be provided for multiple users in various purposes and accordingly an economical servicing method is also required.

First of all, in a system such as a broadcasting system that an identical content is provided for massive multiple users, a dedicated network is used for delivering the content as the content is comprised of massive data. It means that the content to be delivered has no change and accordingly a method in which a bandwidth is going to be used as small as possible in order to increase the efficiency in the aspect of a delivery network rather than in the aspect of contents.

Also, it is necessary to share the identical content in the reason of a cooperative work and so on in services that multiple users, if not massive, participate, such as a video teleconference solution, a tele-education solution and so on. For this, in the existing solution, it is available to decrease the bottleneck phenomenon in a specific node and reduce the bandwidth required for data transmission in a way that the shared contents are delivered from the proxy system representing various terminal systems to the rest of systems.

However, as the high definition content technology that accompanies massive network traffics has been developed and also a need for personalized services has been raised, the conventional solution may not be efficient any more. For example, in case that high resolution contents are played in a low resolution terminal, the servicing is not available, and thus a screen of the terminal should be replaced even though the user is accustomed to use the conventional terminal and the terminal itself does not have any functional problems. As another example, in case that service participants want to be provided with different interest regions based on the interest region which is a kind of a personalized service, the required bandwidths are going to be increased as many as the number of the interest regions since different contents should be delivered according to interest regions instead of adopting the way that an identical content is shared among users any more.

Therefore, in order to provide personalized services, it is required for a delivering method of which characteristic that all of the interest regions are included in an identical content to be utilized while the data by interest region of the content is supported to be delivered.

### SUMMARY OF THE INVENTION

An object of the present invention to solve the problem of described above is to provide a method and system for multilateral contents service in which data is efficiently transmitted and received among participants terminals in the aspect of data volume in order to service the interest region of multiple participants included in a single content of high resolution and the interest region is provided by utilizing shared region in high resolution contents in order to generate the content to be played.

A method for multilateral contents service utilizing shared region of the present invention to accomplish the purpose described above may include by at least one client apparatus, delivering interest region information to a server through a proxy system, by the server, extracting shared region contents for the shared region which is shared among at least one interest region from the original contents, by the server, delivering the shared region contents and, the relevant information between the shared region and the interest region of a first client—the first client is one of the at least one clients—to the proxy system and by the proxy system, generating interest region contents based on the contents and the relevant information received from the server to deliver the interest region contents to the first client apparatus.

When the first client apparatus supports lower resolution than the resolution of the original contents, the first client apparatus may play with an equivalent resolution to the resolution of the original content by receiving the interest region contents

The relevant information between interest region and shared region of the first client may include the shared region information, the overlapped region information which is overlapped with the shared region in the interest region of the first client, and the additional region contents for the additional region except for the shared region in the interest region of the first client.

The information of region—including shared region information, interest region information and overlapped region information—may include coordinate information for a specific point which specifies a region and size information which indicates the size of region.

The step of extracting of the shared region contents performed by the server may include calculating the shared region information and the overlapped region information from the interest region information for the at least one client received from the proxy system and generating the shared region contents and the additional region contents by extracting the data corresponding to the shared region and the additional region from the original contents stored in the database of server. The step of delivering of the interest region information to a server through a proxy system may include calculating interest region information, which is performed by at least one client apparatus, delivering the interest region information to the proxy system, collecting the interest region information of at least one client apparatus and storing in the database, which is performed by the proxy system, and delivering interest region information of at least one client apparatus to the server, which is performed by the proxy system.

The step of collecting of the interest region information of at least one client apparatus and storing in the database performed by the proxy system may include receiving the interest region information and client identifying information from at least one client apparatus performed, which is performed by the proxy system, generating mapping information of the client identifying information and interest region information, and storing the client identifying information, the mapping information and interest region information in the database.

The step of generating the interest region contents to deliver the interest region contents to the first client apparatus may comprise by the proxy system, calculating the interest region by using shared region information and overlapped region information which are received from a server, determining the first client having the interest region which corresponds to the interest region calculated, generating interest region contents by using the shared region contents, additional region contents and interest region information of client and delivering the interest region contents to the first client apparatus.

A system for multilateral contents service utilizing shared region of the present invention to accomplish the purpose described above may include at least one client apparatus configured to deliver interest region information to a server through a proxy system and receive interest region contents based on the interest region information, a server configured to extract shared region contents for the shared region which is shared among at least one interest regions which are received from the at least one client apparatus among the original contents and deliver the shared region contents and, the relevant information between the shared region and interest region of at least one respective client to the proxy system and a proxy system configured to generate interest region contents based on the contents and the relevant information received from the server to deliver the interest region contents to the at least one client apparatus.

When the first client apparatus supports lower resolution than the resolution of the original contents, the first client apparatus may play with an equivalent resolution to the resolution of the original content by receiving the interest region contents.

The relevant information between interest region and shared region of the first client may include the shared region information, the overlapped region information which is overlapped with the shared region in the interest region of the client, and the additional region contents for the additional region except for the shared region in the interest region of the client.

The information of region—including shared region information, interest region information and overlapped region information—may include coordinate information for a specific point which specifies a region and size information which indicates the size of region.

The server may include a calculating unit configured to the calculate the shared region information and the overlapped region information from the interest region information for at least one client received from the proxy system, a contents generating unit configured to generate the shared region contents and the additional region contents by extracting the data corresponding to the shared region and the additional region from the original contents stored in the database of server and a delivering unit configured to deliver the shared region contents, the additional region contents, the shared region information and the overlapped region information to the proxy system.

The client apparatus may include a calculating unit configured to calculate the interest region information, a delivering unit configured to deliver the interest region information to the proxy system, a receiving unit configured to receive the interest region contents from the proxy system, and a playing unit configured to play the interest region contents.

The proxy system may include a mapping information generating unit configured to generate mapping information of client identifying information and the interest region information received the at least one of clients, a database configured to store the mapping information and the interest region information, an interest region calculating unit configured to calculate the interest region by using the shared region information and the overlapped region information received from the server, a determining unit configured to determine a client having interest region corresponding to the calculated interest region by using the mapping information, a contents generating unit configured to generate the interest region contents by using the shared region contents, the additional region contents and the interest region information of each of the at least one clients and 3qa delivering unit configured to deliver the interest region contents to the client apparatus.

### BRIEF DESCRIPTION OF THE DRAWINGS

FIG. 1 is a block diagram schematically illustrating the configuration of a system for multilateral contents service utilizing shared region according to an embodiment of the present invention.

FIG. 2 is a detailed block diagram specifically illustrating a server's configuration of a system for multilateral contents service utilizing shared region according to an embodiment of the present invention.

FIG. 3 is a drawing illustrating the configuration of embodiments and region information of shared region, interest region and overlapped region in a specific screen.

FIG. 4 is a detailed block diagram specifically illustrating the configuration of a proxy system of a system for multilateral contents service utilizing shared region according to an embodiment of the present invention.

FIG. 5 is a drawing illustrating an exemplary feature of generating interest region contents by using relevant information and contents date.

FIG. 6 is a details block diagram specifically illustrating the configuration of a client apparatus of a system for multilateral contents service utilizing shared region according to an embodiment of the present invention.

### DETAILED DESCRIPTION OF THE INVENTION

The inventive subject matter now will be described more fully hereinafter with reference to the accompanying drawings, in which embodiments of the present invention are shown.

However, the present invention may be embodied in many different forms, modifications, equivalents and alternatives, which are included in the inventive concept and scope, and should not be construed as limited to the embodiments set forth herein.

Although the terms first, second, etc. may be used herein to describe various elements, it will be understood that these elements should not be limited by these terms. These terms are only used to distinguish one element from another. For example, a first element could be termed a second element, and similarly, a second element could be termed a first element without departing from the scope of the present invention. Herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening element present.

The terminology used herein is for the purpose of describing particular embodiments only and is not intended to be limiting of the present invention. As used herein, the singular forms are intended to include the plural forms as well, unless the context clearly indicates otherwise. It will be further understood that the terms “comprise” or “include” etc. when being used in this specification specify the presence of stated features, numbers, steps, operations, elements, components or combination of these things, but do not preclude the presence or addition of one or more other features, numbers, steps, operations, elements, components or combination of these things.

Unless otherwise defined, all terms including technical or scientific terms used herein have the same meaning as commonly understood by one of ordinary skill in the art to which the present invention belongs. It will be further understood that the terms such as those defined in commonly used dictionary should be interpreted as having a meaning that is consistent with their meaning in the context of the relevant art, and will not be interpreted in an idealized or overly formal sense unless expressly so defined herein.

The inventive subject matter now will be described more fully hereinafter by reference to the accompanying drawings, in which embodiments of the present invention are shown. In describing embodiments of the present invention, the same reference numeral is used for the same element even in order to be easily understood throughout the specification, and the redundant description for the same element will be omitted.

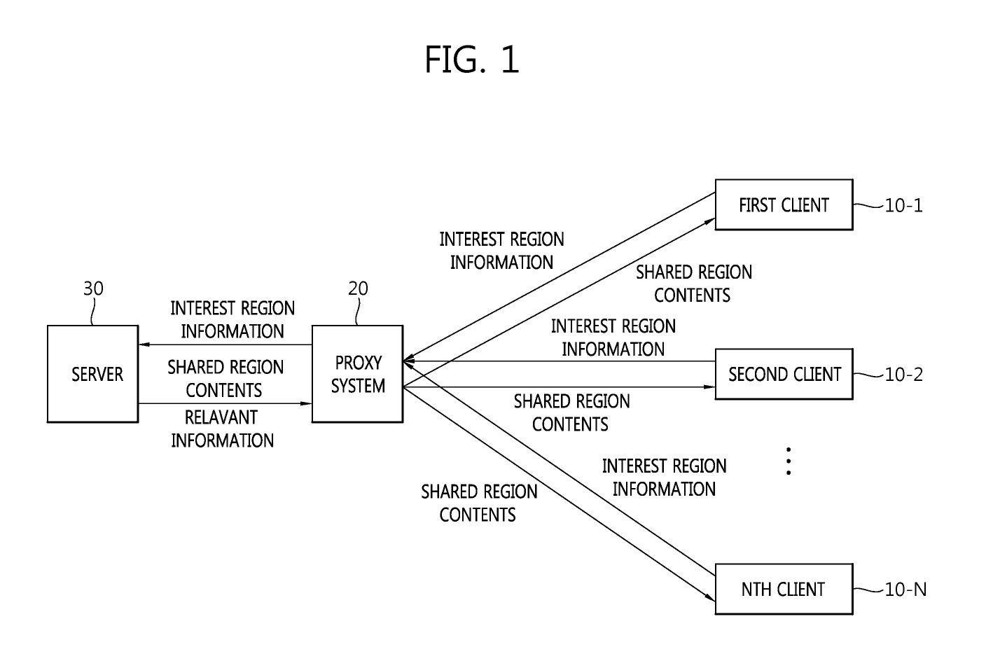

FIG. 1 is a block diagram schematically illustrating the configuration of a system for multilateral contents service for utilizing shared region according to an embodiment of the present invention. As depicted in FIG. 1, the system for multilateral contents service utilizing shared region according to an embodiment of the present invention may include at least one client apparatus 10-1, 10-2, . . . , 10-N, a proxy system 20 and a server 30.

Referring to FIG. 1, the client apparatuses 10-1, 10-2, . . . , 10-N transmits interest region information to the proxy system 20. The interest region may imply the region of which the client apparatuses 10-1, 10-2, . . . , 10-N are going to play by raising resolution for a specific region in a specific contents screen. The client apparatuses 10-1, 10-2, . . . , 10-N may be provided with high resolution screen for interest region by selectively transmitting interest region information to the proxy system 20. The client apparatuses 10-1, 10-2, . . . , 10-N may be plural, a plurality of the client apparatuses 10-1, 10-2, . . . , 10-N may transmit respective personalized interest region information to the proxy system 20. The meaning of personalized interest region information implies that it may be different between the interest region of first client 10-1 and that of second client 10-2. The client apparatuses 10-1, 10-2, . . . , 10-N may receive interest region contents generated by the proxy system 20 and the server 30 based on the interest region information. According to the personalized interest region, interest region contents may be different for respective client apparatuses 10-1, 10-2, . . . , 10-N. The client apparatuses 10-1, 10-2, . . . , 10-N may play the interest region contents received.

The proxy system 20 receives interest region information from at least one client apparatus 10-1, 10-2, . . . , 10-N and delivers it to the server 30. The proxy system 20 stores the interest region information of client apparatuses 10-1, 10-2, . . . , 10-N in the database, receives shared region contents received from the server 30 and the relevant information of interest region and shared region (the relevant information may include additional region contents, shared region information and overlapped region information), and generates interest region contents by using the interest region information of client apparatuses 10-1, 10-2, . . . , 10-N stored in the database.

The server 30 extracts shared region contents and additional region contents from the original contents by using the interest region information of at least on of client apparatuses 10-1, 10-2, . . . , 10-N. The shared region is a region which is shared among interest regions of multiple client apparatuses 10-1, 10-2, . . . , 10-N executed in the proxy system, the additional region is a region in which shared region is excluded from interest region. The server 30 may extract shared region contents and additional region contents and deliver shared region contents, additional region contents, shared region information and overlapped region information to the proxy system 20.

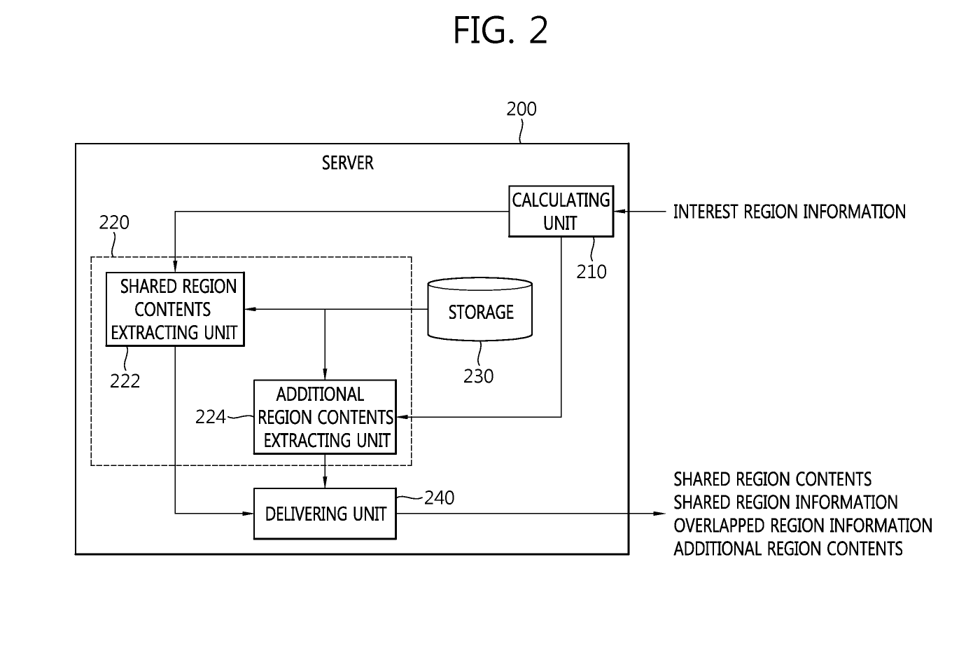

FIG. 2 is a detailed block diagram specifically illustrating a server's configuration of a system for multilateral contents service utilizing shared region according to an embodiment of the present invention. As depicted in FIG. 2, the server 200 according to an embodiment of the present invention may include a calculating unit 210, a contents extracting unit 220, a contents storage 230 and a delivering unit 240.

Referring to FIG. 2, the calculating unit receives interest region information for respective clients (not shown in FIG. 2) from a proxy system (not shown in FIG. 2), and calculates shared region information and overlapped region information. The shared region information represents a region shared among interest regions of the client, and through the shared region information, shared region contents and additional region contents for a specific client may be extracted. Among interest regions of the client, the more is the part that shared region occupies, the smaller is the bandwidth required for services and it may be advantageous in the aspect of the transmission efficiency.

The shared region may be calculated in various ways by using interest region information of multiple clients. For example, in the aspect of providing services, the server 200 may fix the size of interest region. The size of interest region may be set differently according to the resolution of the corresponding contents. The size of multiple clients' interest regions may be fixed by service setting of the server 200, and the server 200 may be calculated to be corresponded to the size of interest region set from the central part of a screen. If the size of interest regions of multiple clients is width 1024 and length 768, the region which has a size of width 1024 and length 768 from the center of a screen may be calculated as the shared region.

Or, it is adjustable for the shared region to be located towards on the part where interest regions of the client are concentrated not necessary to be located in the center of a screen. This may be calculated through the size of overlapped region. For example, if interest regions of the client are concentrated on the left part such as the upper part of the left, the bottom of the left etc, it is inefficient to form the shared region from the central part, and so the shared region may be located in the left part. In this time, the part where the size of overlapped region is the maximum may be the shared region.

According to another embodiment of the present invention, the server 200 may differently set the size of shared region according to the size of interest region of multiple clients, if the size of shared region is not fixed. The size of shared region may correspond to the maximum size or minimum size and also available to a middle size among sizes of interest regions of the client. If the size of shared region is decided, as described previously, it may be calculated for the part where the size of overlapped region is the maximum to be the shared region.

According to another embodiment of the present invention, the server 200 may fix the location and size of shared region.

The calculating unit 210 generates overlapped region information by calculating shared region and calculating the overlapped region which is overlapped with the shared region among interest regions of the client.

The contents extracting unit 220 is a component for extracting a specific content from the contents storage 230, may include a shared region contents extracting unit 222 and additional region contents extracting unit 224. The shared region contents extracting unit 222 extracts the contents corresponding to the relevant shared region by using shared region information from the calculating unit 210, in the original contents data stored in the contents storage 230. As shared region contents are the contents that are applied to clients participating in the multilateral contents service in common, it is only required to extract one content while the service is offered.

The additional region contents extracting unit 224 may extract the remnant regions except for the shared region from interest regions of respective clients, that is the contents that corresponds to the additional region by using the shared region information in the original contents data stored in the contents storage 230. The additional region contents extracting unit 224 may respectively extract the additional region contents that correspond to respective clients, by figuring out the interest region of respective clients by a client.

The contents storage 230 has the data of the original contents, the delivering unit 240 delivers shared region contents, additional region contents, shared region information and overlapped region information to a proxy system. The proxy system generates interest region contents by using shared region contents and additional region contents.

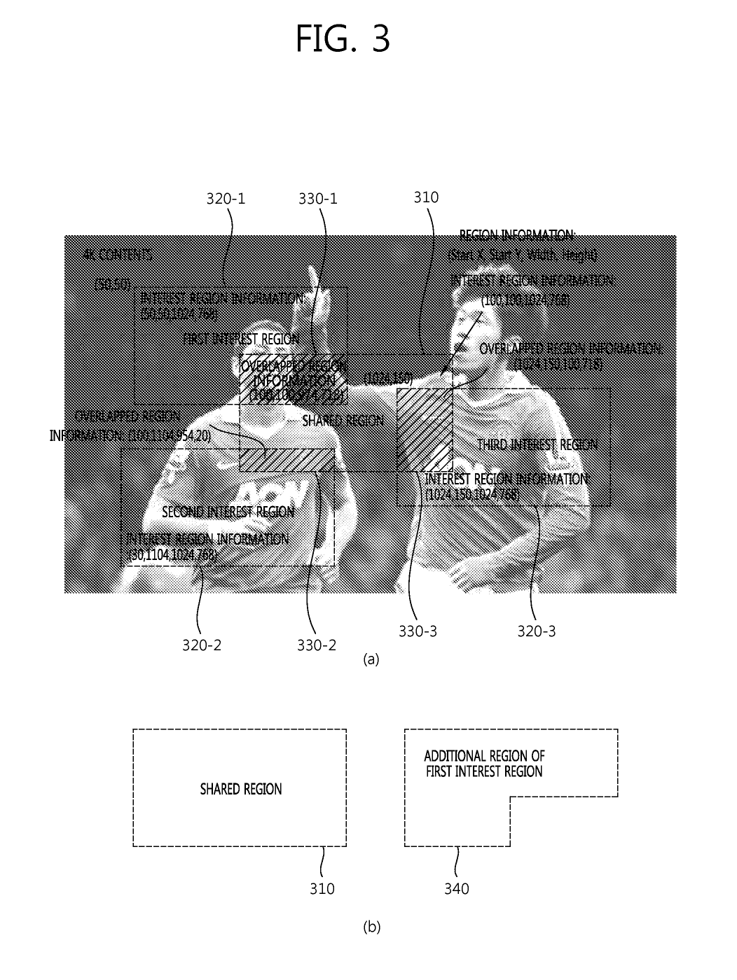

FIG. 3 is a drawing illustrating the configuration of embodiments and region information of shared region, interest region and overlapped region in a specific screen.

Referring to FIG. 3 (a), the shared region 310 is located in the center of a screen, and includes the parts that are overlapped with the first interest region 320-1, the second interest region 320-2, and the third interest region 320-3. The shared region 310 has the overlapped regions 330-1, 330-2, 330-3 that are overlapped with the respective interest regions 320-1, 320-2, 320-3, and may generate overlapped region information by calculating the overlapped regions 330-1, 330-2, 330-3 that are overlapped the shared region 310 in the respective interest regions 320-1, 320-2, 320-3. The information of respective regions (may include shared region information, interest region information, overlapped region information and additional region information, etc.) is represented as coordinate information which may specify the location of the region, for example, (50, 50), and represented as size information which may specify the size of the region, for example, (1024, 768).

FIG. 3 (b) is a drawing that illustrates an exemplary feature of shared region and additional region.

Referring to FIG. 3 (b), by using the shared region 310 information, the information of the additional region 340 may be obtained exclusive of the shared region 310 from the first interest region 320-1 of each client. That is, by combining the shared region 310 contents and the additional region 340 contents, the contents of the first interest region 320-1 may be generated.

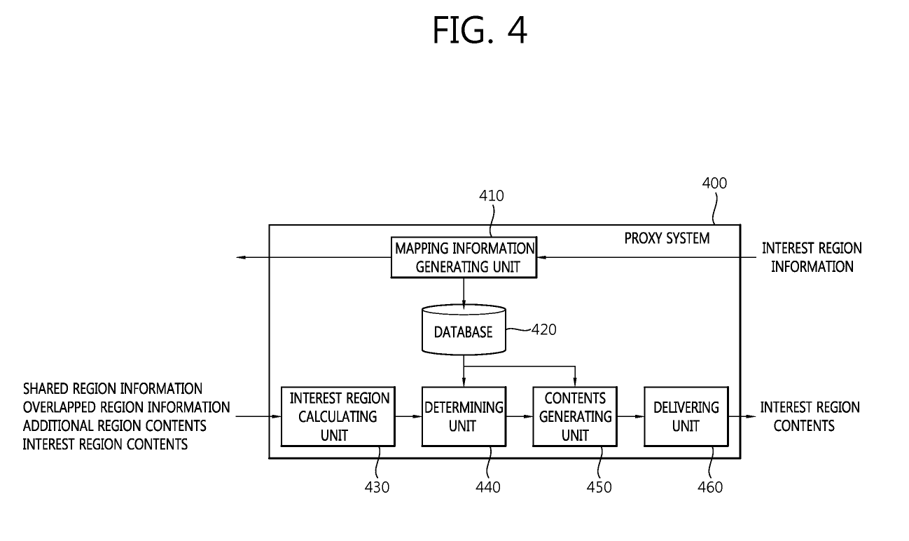

FIG. 4 is a detailed block diagram specifically illustrating the configuration of a proxy system of a system for multilateral contents service utilizing shared region according to an embodiment of the present invention. As depicted in FIG. 4, the proxy system 400 may include a mapping information generating unit 410, a database 420, an interest region calculating unit 430, a determining unit 440, a contents generating unit 450, and a delivering unit 460.

Referring to FIG. 4, the mapping information generating unit 410 generates the mapping information for multiple interest regions information and each client that are received by a client apparatus. The mapping information may include the client identifying information and the interest region information of the corresponding client. The mapping information may be used for matching a client apparatus corresponding to the interest region information that is calculated based on the shared region information and overlapped region information that are received from the server.

The database 420 stores interest region information and mapping information.

The interest region calculating unit 430 calculates the interest region information by using the shared region information and relevant information (shared region information, overlapped region information and additional region information etc.) that are received from the server.

The determining unit 440 determines to which client the calculated interest region information belongs. For this determination, the mapping information that stored in the database 420 may be utilized. The mapping information includes the identifying information of the client that corresponds to specific interest region information. The determining unit 440 may determine the corresponding client if checking the database by inputting the calculated interest region information.

The contents generating unit 450 generates the interest region contents based on the clients' interest region information that is determined in the determining unit 440 and the shared region contents and additional region contents that are received from the server.

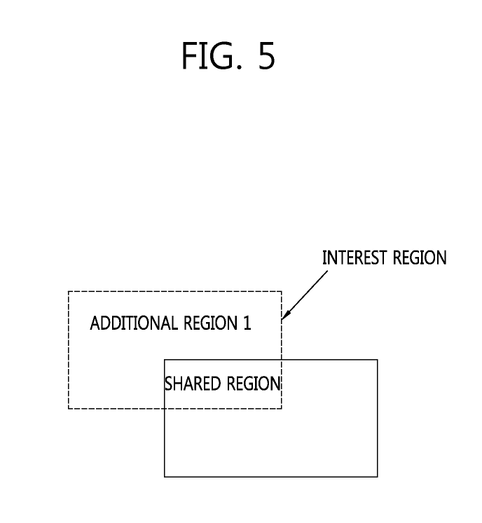

FIG. 5 is a drawing illustrating an exemplary feature of generating interest region contents by using relevant information and contents date.

Referring to FIG. 5, the interest region contents may be generated by combining the received shared region contents and additional region contents. In this time, by using the overlapped region information, the contents for the overlapped part among shared region contents may be extracted. When combining the contents for the overlapped part and additional region contents, it may be figured out through the interest region information of the determined client whether it coincides with the interest region of a specific client. If it corresponds to the interest region information, the combined contents may be the interest region contents of the corresponding client.

Going back to FIG. 4 again, the delivering unit 460 forwards the contents generated in the contents generating unit 450 to the corresponding apparatus.

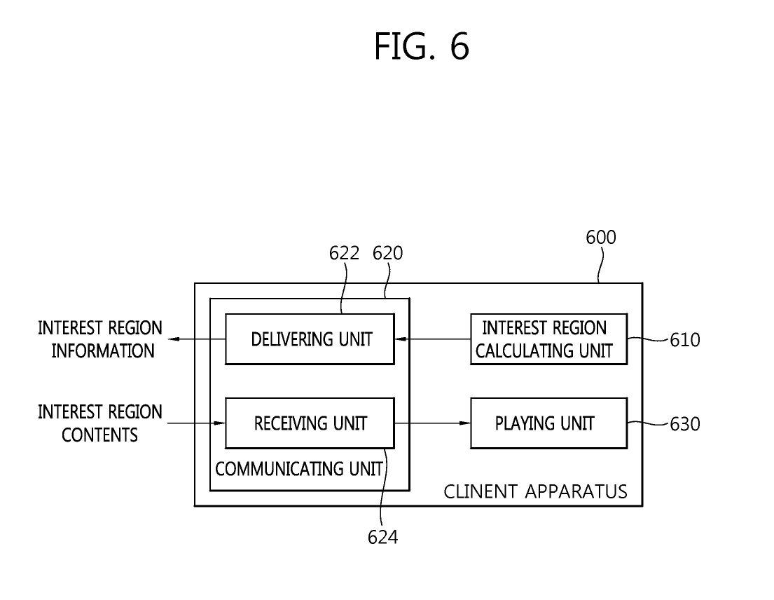

FIG. 6 is a details block diagram specifically illustrating the configuration of a client apparatus of a system for multilateral contents service utilizing shared region according to an embodiment of the present invention. As depicted in FIG. 6, the client apparatus 600 may include an interest region calculating unit 610, a communicating unit 610, and a playing unit 630.

Referring to FIG. 6, the interest region calculating unit 610 calculates the interest region information by receiving the input of the interest region from a user. The input for the interest region may be executed through the users' interface (not shown in FIG. 6). The interest region may be calculated according to the terminal performance of the client apparatus 600. For example, in case that the terminal performance is lower than the resolution of the original contents, the interest region size may be determined in order to be played according to the resolution of the original contents. The interest region calculating unit 610 generates the interest region information by calculating the coordinate information and size information of the interest region inputted through the users' interface.

The communicating unit 620 may include a delivering unit 622 and a receiving unit 624. The delivering unit 622 may forward the interest region information that is calculated in the interest region calculating unit 610 to the proxy system. The receiving unit 624 may receive the interest region contents from the proxy system.

The playing unit 630 may play the interest region contents received. In this time, as described previously, even if the terminal performance falls short of the resolution of the original contents, the interest region contents may be played in an identical resolution with that of the original contents.

So far, the present invention has been described with reference to the drawings and the embodiments, which does not mean the scope of the present invention is not limited thereto, and it should be understood by those skilled in the art, however, that the present invention can be modified or changed in various ways without departing from the technical principles and scope.

What is claimed is:

1. A method for multilateral contents service utilizing shared region, comprising:
by at least one client apparatus, delivering interest region information to a server through a proxy system;
by the server, extracting shared region contents for the shared region which is shared among at least one interest region from the original contents;
by the server, delivering the shared region contents and, the relevant information between the shared region and the interest region of a first client—the first client is one of the at least one clients—to the proxy system; and
by the proxy system, generating interest region contents based on the contents and the relevant information received from the server to deliver the interest region contents to the first client apparatus.

2. The method of claim 1, wherein when the first client apparatus supports lower resolution than the resolution of the original contents, the first client apparatus plays with an equivalent resolution to the resolution of the original content by receiving the interest region contents.

3. The method of claim 1, wherein the relevant information between the interest region and the shared region of the first client comprises the shared region information, the overlapped region information which is overlapped with the shared region in the interest region of the first client, and the additional region contents for the additional region except for the shared region in the interest region of the first client.

4. The method of claim 3, wherein the information of region—including shared region information, interest region information and overlapped region information—comprises coordinate information for a specific point which specifies a region and size information which indicates the size of region.

5. The method of claim 3, wherein extracting of the shared region contents comprises:
calculating the shared region information and the overlapped region information from the interest region information for the at least one client received from the proxy system; and
generating the shared region contents and the additional region contents by extracting the data corresponding to the shared region and the additional region from the original contents stored in the database of server.

6. The method of claim 1, wherein delivering of the interest region information to a server through a proxy system comprises:
by the at least one client apparatus, calculating interest region information;
delivering the interest region information to the proxy system;
by the proxy system, collecting the interest region information of at least one client apparatus to store in database; and
by the proxy system, delivering interest region information of at least one client apparatus to the server.

7. The method of claim 6, wherein collecting of the interest region information of at least one client apparatus to store in the database comprises:
by the proxy system, receiving the interest region information and client identifying information from at least one client apparatus;
generating mapping information of the client identifying information and interest region information; and
storing the client identifying information, the mapping information and the interest region information in the database.

8. The method of claim 1, wherein generating the interest region contents to deliver the interest region contents to the first client apparatus comprises:
by the proxy system, calculating the interest region by using shared region information and overlapped region information which are received from a server;
determining the first client having the interest region which corresponds to the interest region calculated;
generating interest region contents by using the shared region contents, additional region contents and interest region information of client; and
delivering the interest region contents to the first client apparatus.

9. A system for multilateral contents service utilizing shared region, comprising,
at least one client apparatus configured to deliver interest region information to a server through a proxy system and receive interest region contents based on the interest region information;
a server configured to extract shared region contents for the shared region which is shared among at least one interest regions which are received from the at least one client apparatus among the original contents and deliver the shared region contents and, the relevant information between the shared region and interest region of at least one respective client to the proxy system; and
a proxy system configured to generate interest region contents based on the contents and the relevant information received from the server to deliver the interest region contents to the at least one client apparatus.

10. The system of claim 9, wherein when the first client apparatus supports lower resolution than the resolution of the original contents, the first client apparatus plays with an equivalent resolution to the resolution of the original content by receiving the interest region contents.

11. The system of claim 9, wherein the relevant information between interest region and shared region of the first client comprises the shared region information, the overlapped region information which is overlapped with the shared region in the interest region of the client, and the additional region contents for the additional region except for the shared region in the interest region of the client.

12. The system of claim 11, wherein the information of region—including shared region information, interest region information and overlapped region information—comprises coordinate information for a specific point which specifies a region and size information which indicates the size of region.

13. The system of claim 11, wherein the server comprises:
a calculating unit configured to the calculate the shared region information and the overlapped region information from the interest region information for at least one client received from the proxy system;
a contents generating unit configured to generate the shared region contents and the additional region contents by extracting the data corresponding to the shared region and the additional region from the original contents stored in the database of server; and
a delivering unit configured to deliver the shared region contents, the additional region contents, the shared region information and the overlapped region information to the proxy system.

14. The system of claim 9, wherein the client apparatus comprises:
a calculating unit configured to calculate the interest region information;
a delivering unit configured to deliver the interest region information to the proxy system;
a receiving unit configured to receive the interest region contents from the proxy system; and
a playing unit configured to play the interest region contents.

15. The system of claim 14, wherein the proxy system comprises:
a mapping information generating unit configured to generate mapping information of client identifying information and the interest region information received the at least one of clients;
a database configured to store the mapping information and the interest region information;
an interest region calculating unit configured to calculate the interest region by using the shared region information and the overlapped region information received from the server;
a determining unit configured to determine a client having interest region corresponding to the calculated interest region by using the mapping information;
a contents generating unit configured to generate the interest region contents by using the shared region contents, the additional region contents and the interest region information of each of the at least one clients; and
a delivering unit configured to deliver the interest region contents to the client apparatus.
